(19) United States
(12) Patent Application Publication
(10) Pub. No.: US 2026/0302740 A1
(43) Pub. Date: Oct. 1, 2026

(54) LOW VOLTAGE WIRE HOLDER

(71) Applicant: Leonel Fernandez, Miami, FL (US)

(72) Inventor: Leonel Fernandez, Miami, FL (US)

(21) Appl. No.: 19/094,791

(22) Filed: Mar. 28, 2025

Related U.S. Application Data
(60) Provisional application No. 63/626,007, filed on Jan. 28, 2024.

(51) Int. Cl. H02G 3/04; H02G 3/22; H02G 3/38

(52) U.S. Cl. CPC H02G 3/0418; H02G 3/22; H02G 3/381; H02G 3/386

(57) ABSTRACT

A low voltage wire holder apparatus may comprise a square surface having a circular opening. Two elongated boards may extend from the square surface for attachment to wall studs. A drywall guide may be on the square surface. An end cap may be configured to cover the circular opening. The square surface may provide a mounting point for equipment. The circular opening may provide access to pre-run wires behind drywall. The drywall guide may protect wires during drywall installation. A wire strap may be on a back side of the square surface. A wire hole may be on the square surface. The apparatus may be constructed of PVC. The apparatus may be installed between wall, ceiling studs, or any part of framing before drywall installation. Low voltage wires may be run through the holder. Equipment may be installed by screwing directly into the square surface.

### CROSS-REFERENCE TO RELATED APPLICATIONS

This application claims the benefit of U.S. Provisional Application No. 63/626,007, filed Jan. 28, 2024, which is incorporated herein by reference in its entirety.

### FIELD OF THE INVENTION

The present disclosure relates generally to wire management systems, and more particularly to a low voltage wire holder for use in building construction.

### BACKGROUND

In building construction, it is common practice for low voltage electricians to run wiring before drywall installation. However, accessing and managing these pre-run wires after drywall installation can be challenging. There is a need for a solution that allows easy storage and access to pre-run low voltage wires once drywall is installed, while also providing a secure mounting point for equipment.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a low voltage wire holder apparatus may be provided. The apparatus may include a square surface with a circular opening, two elongated boards for attachment to studs, a drywall guide, and an end cap. The apparatus may be designed for holding and facilitating the running of low voltage wires and may act as an anchor for later installation of equipment. In another aspect, the apparatus may provide a clean sleek look until the time of installation.

In another aspect, a method of using a low voltage wire holder may be provided. The method may include installing the low voltage wire holder between wall studs before drywall installation, running low voltage wires through the holder, accessing pre-run wires through a circular opening after drywall installation, and installing equipment by screwing directly into the square surface of the holder.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated in and constitute a part of this specification, illustrate one or more embodiments of the invention and, together with the description, explain the invention. In the drawings:

FIG. 1 shows a bottom perspective view of an end cap for a low voltage wire holder, in accordance with one or more embodiments described herein.

FIG. 2 shows a top perspective view of the end cap for the low voltage wire holder, in accordance with one or more embodiments described herein.

FIG. 3 shows a perspective view of a low voltage wire holder, in accordance with one or more embodiments described herein.

FIG. 4 shows another perspective view of the low voltage wire holder, in accordance with one or more embodiments described herein.

FIG. 5 shows a perspective view of the low voltage wire holder attached to studs with wire running through it, in accordance with one or more embodiments described herein.

FIG. 6 shows a perspective view of the low voltage wire holder attached to studs with wire running through it, in accordance with one or more embodiments described herein.

FIG. 7 shows a view of the low voltage wire holder attached to studs with wire running through it, in accordance with one or more embodiments described herein.

FIG. 8 shows a view of the low voltage wire holder attached to studs with wire running through it, in accordance with one or more embodiments described herein.

FIG. 9 shows a view of the low voltage wire holder attached to studs with wire running through it, in accordance with one or more embodiments described herein.

FIG. 10 shows a view of the low voltage wire holder attached to studs with wire running through it, in accordance with one or more embodiments described herein.

FIG. 11 shows a view of the low voltage wire holder attached to studs with wire running through it, in accordance with one or more embodiments described herein.

FIG. 12 shows a view of the low voltage wire holder attached to studs with wire running through it, in accordance with one or more embodiments described herein.

FIG. 13 shows a view of the low voltage wire holder attached to studs with wire running through it, in accordance with one or more embodiments described herein.

FIG. 14 shows a view of the low voltage wire holder attached to studs with wire running through it, in accordance with one or more embodiments described herein.

FIG. 15 shows a view of the low voltage wire holder attached to studs with wire running through it, in accordance with one or more embodiments described herein.

FIG. 16 shows a view of the low voltage wire holder attached to studs with wire running through it, in accordance with one or more embodiments described herein.

FIG. 17 shows a view of the low voltage wire holder attached to studs with wire running through it, in accordance with one or more embodiments described herein.

FIG. 18 shows a view of the low voltage wire holder attached to studs with wire running through it, in accordance with one or more embodiments described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure relates to a low voltage wire holder apparatus designed for holding and facilitating the running of low voltage wires and acting as an anchor for the later installation of equipment. The low voltage holder may be installed in the framing before the drywall is installed.

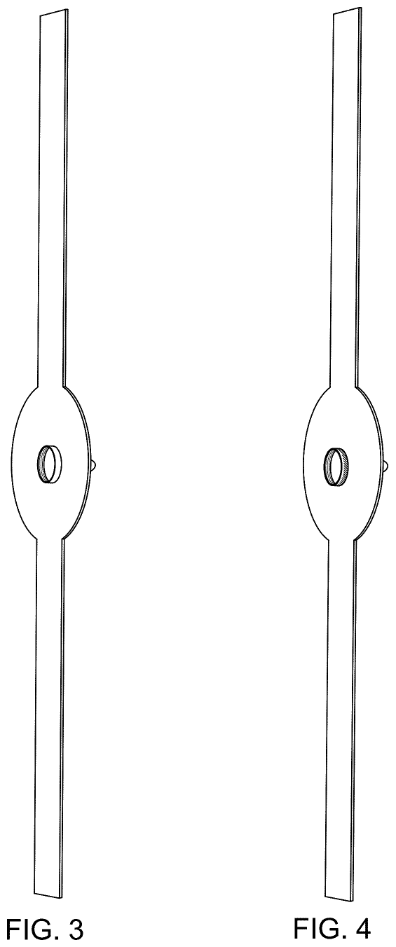

Referring now to FIG. 3, a perspective view of a low voltage wire holder 300 is shown. The low voltage wire holder 300 may include a square surface 302 with two elongated boards 304, 306 to attach to the nearest studs. The square surface 302 may have a circular opening 308 which may provide access behind the wall after the drywall is put up. This circular opening 308 may allow a low voltage electrician to have easy access to pre-run low voltage wiring and set up any type of equipment which requires it.

The low voltage wire holder 300 may also include a drywall guide 310. The drywall guide 310 may protect the wire during drywall installation. In some embodiments, the low voltage wire holder 300 may be constructed of PVC or other suitable material that can withstand the building construction environment.

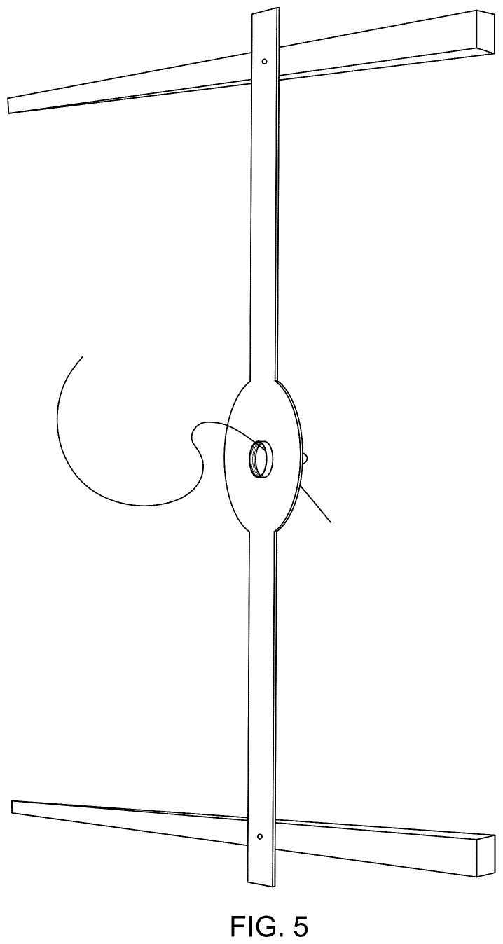

Referring now to FIG. 4, another perspective view of the low voltage wire holder 300 is shown. This view may show the back side of the low voltage wire holder 300. A wire strap 402 may be provided on the back side to hold the wire in place. A wire hole 404 may also be provided for the wire to pass through.

Referring now to FIG. 5, a perspective view of the low voltage wire holder 300 attached to studs 502, 504 is shown. A wire 506 may be shown running through the low voltage wire holder 300. This figure illustrates how the low voltage wire holder 300 may be installed in a typical construction setting.

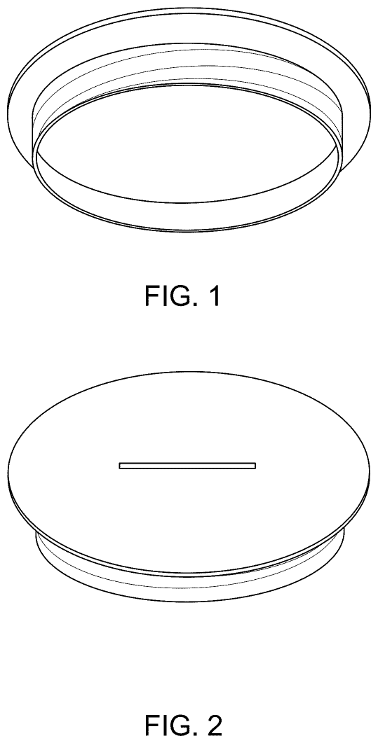

Referring now to FIGS. 1 and 2, bottom and top perspective views of an end cap 100, 200 for the low voltage wire holder 300 are shown, respectively. When the low voltage wire holder apparatus is not in use, the end cap 100, 200 may be placed over the circular opening 308 to hide the hole.

In operation, the low voltage wire holder 300 may be installed between wall studs before drywall installation. Low voltage wires may be run through the holder 300. After drywall installation, a low voltage electrician may be able to gain access to the pre-run wiring through the circular opening 308.

When it becomes time for the installation of cameras, Wi-Fi extenders, or other devices, the device may be screwed directly into the square surface 302 of the low voltage wire holder 300 instead of needing to use drywall anchors. This may provide a secure mounting point for equipment.

The low voltage wire holder 300 may transform pre-drywall wire installation into a post-drywall accessible system. It may convert standard wall space into a dedicated wire management and equipment mounting location. The process of equipment installation may be changed from using drywall anchors to direct mounting on a secure surface. Hidden, inaccessible wires may be transformed into easily accessible and manageable wiring systems.

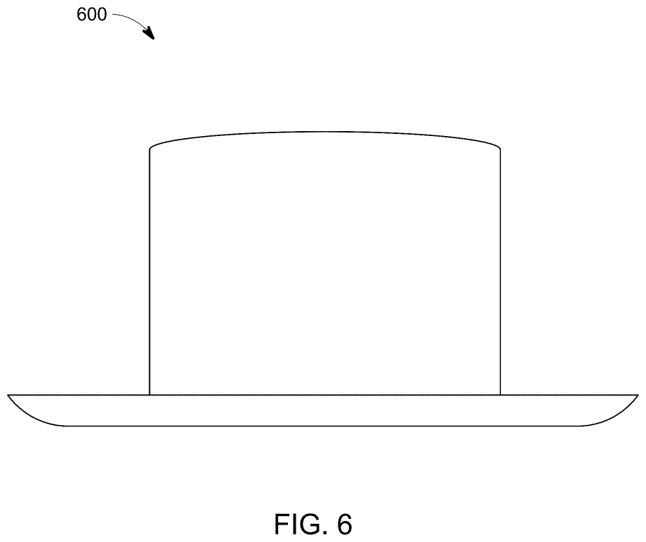

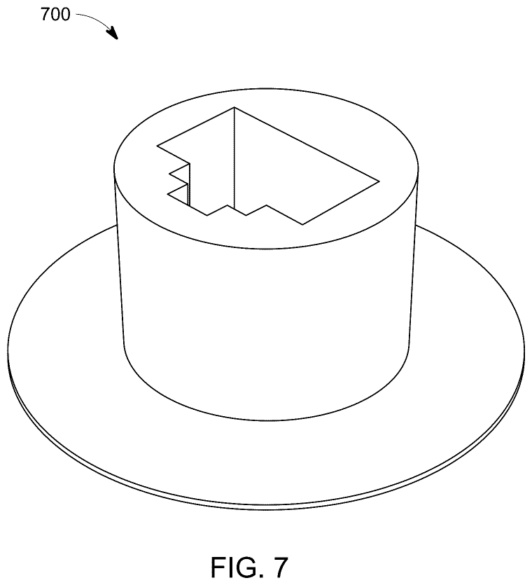

Referring now to FIG. 6, a perspective view of an end cap 600 for the low voltage wire holder is shown. The end cap 600 may have a cylindrical shape with a flat circular top surface and a wider circular base. The cylindrical shape may be configured to fit snugly into the circular opening 308 of the low voltage wire holder 300. The wider base may provide a flush finish when the end cap 600 is inserted into the circular opening 308. The end cap 600 may be constructed of the same material as the low voltage wire holder 300, such as PVC, to maintain consistency in appearance and durability.

FIG. 7 illustrates a bottom view of the end cap 600. The bottom surface of the end cap 600 may include a threaded portion 702 that may be configured to engage with corresponding threads within the circular opening 308 of the low voltage wire holder 300. This threaded engagement may ensure a secure fit and allow for easy removal and replacement of the end cap 600 as needed.

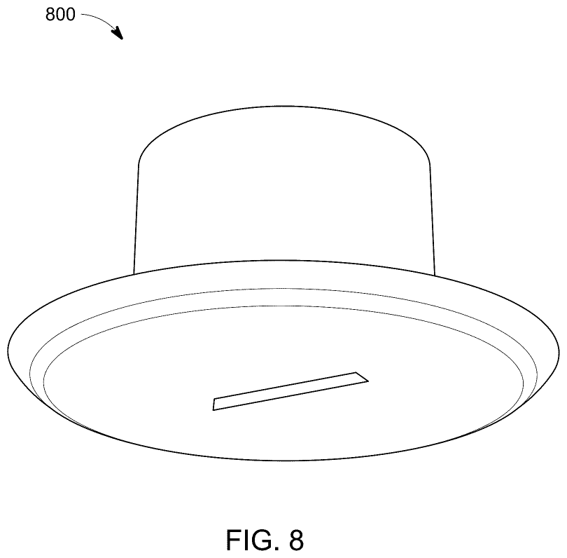

Turning to FIG. 8, a side view of the end cap 600 is depicted. The side view may show the profile of the end cap 600, including its cylindrical body 802 and the wider base 804. The cylindrical body 802 may be dimensioned to match the depth of the circular opening 308 in the low voltage wire holder 300, ensuring that the end cap 600 sits flush with the surface of the holder when fully inserted.

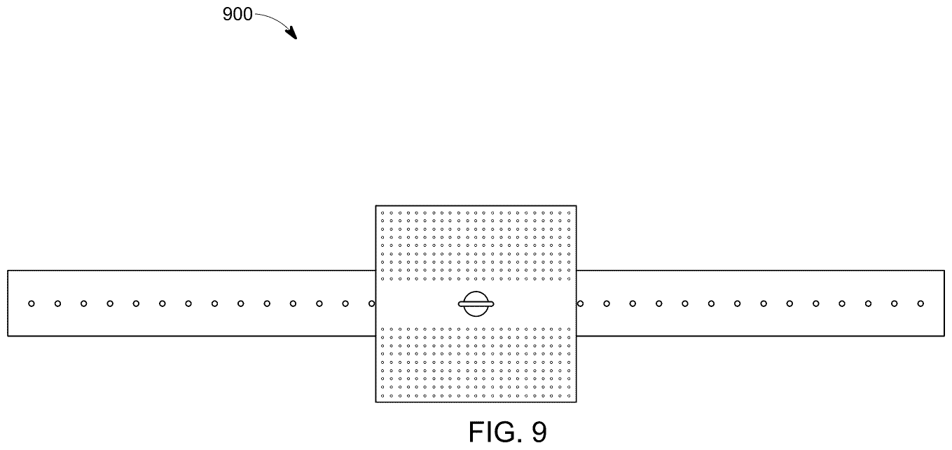

FIG. 9 presents a cross-sectional view of the low voltage wire holder 300 with the end cap 600 installed. The cross-section may reveal how the end cap 600 fits into the circular opening 308, with the threaded portion 702 of the end cap engaging with corresponding threads 902 within the circular opening 308. This view may also show how the wider base 804 of the end cap 600 rests against the surface of the low voltage wire holder 300, providing a seamless appearance.

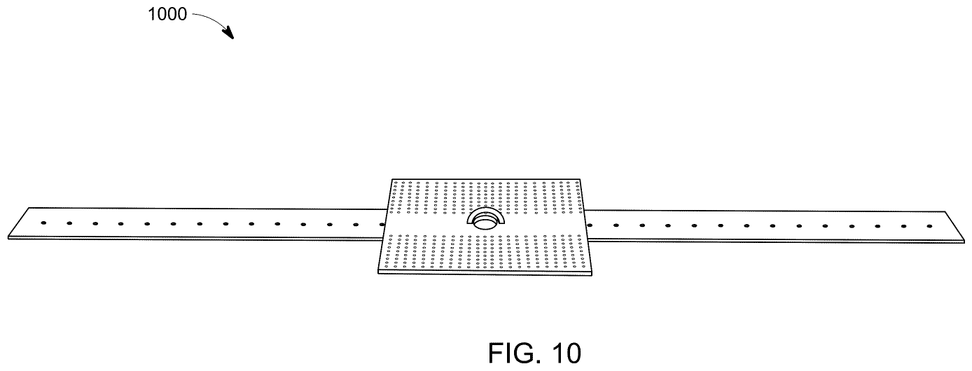

Referring to FIG. 10, a detailed view of the interface between the end cap 600 and the circular opening 308 is shown. This view may highlight the threaded engagement between the end cap 600 and the low voltage wire holder 300. It may also show any sealing mechanisms, such as a rubber gasket 1002, that may be incorporated to ensure a weather-tight seal when the end cap 600 is installed.

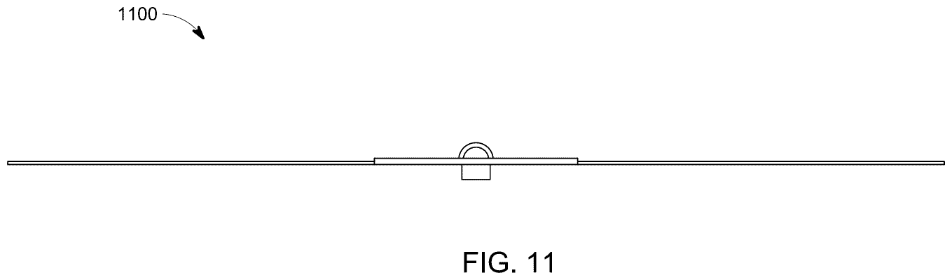

FIG. 11 illustrates an exploded view of the low voltage wire holder 300 and its components, including the end cap 600. This view may show how the various components of the system fit together, including the square surface 302, the elongated boards 304, 306, the drywall guide 310, and the end cap 600. The exploded view may provide a clear understanding of the assembly process and the relationship between the different parts of the low voltage wire holder system.

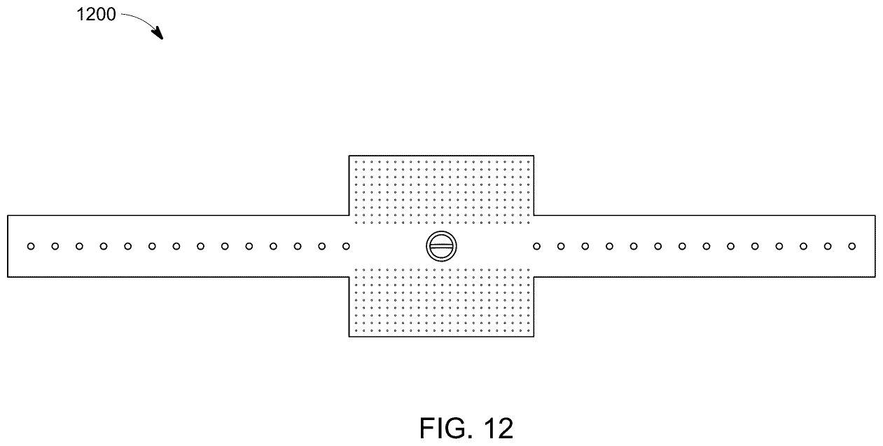

Turning to FIG. 12, a perspective view of an alternative embodiment of the low voltage wire holder 1200 is shown. This embodiment may feature a modified shape for the square surface, such as a rectangular or oval shape. The alternative embodiment may also include additional features such as multiple circular openings 1202, 1204 to accommodate different sizes or types of low voltage wires.

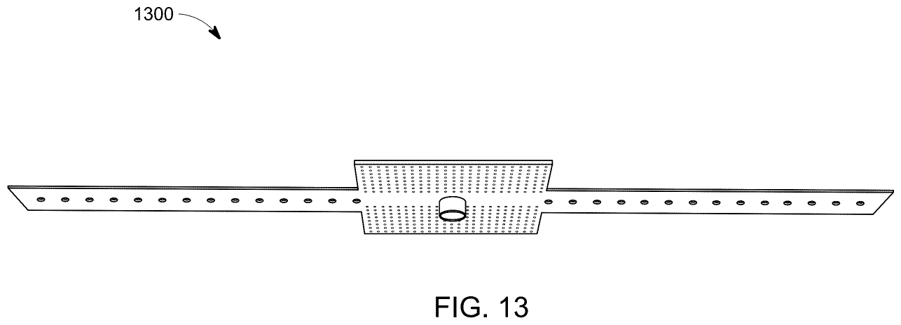

FIG. 13 depicts a rear view of the alternative embodiment of the low voltage wire holder 1200. This view may show modified wire management features, such as multiple wire straps 1302, 1304 or a redesigned wire hole 1306. These modifications may allow for greater flexibility in wire routing and management within the holder.

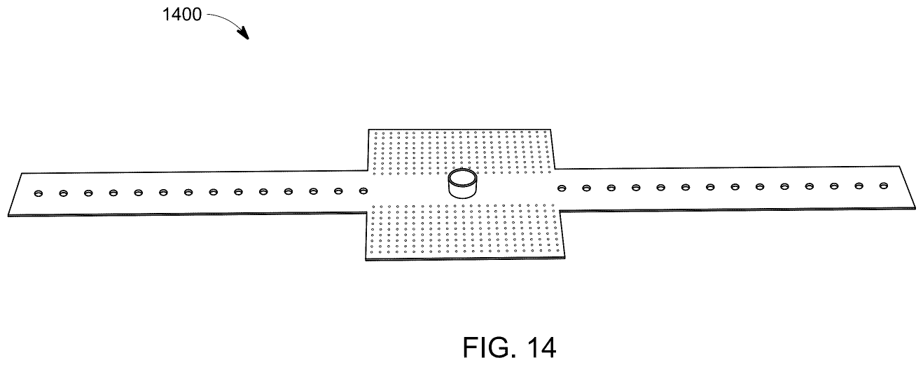

Referring to FIG. 14, a side view of the alternative embodiment of the low voltage wire holder 1200 is presented. This view may highlight any changes in the profile of the holder, such as a curved or angled surface 1402 designed to better accommodate corner installations or unique wall configurations.

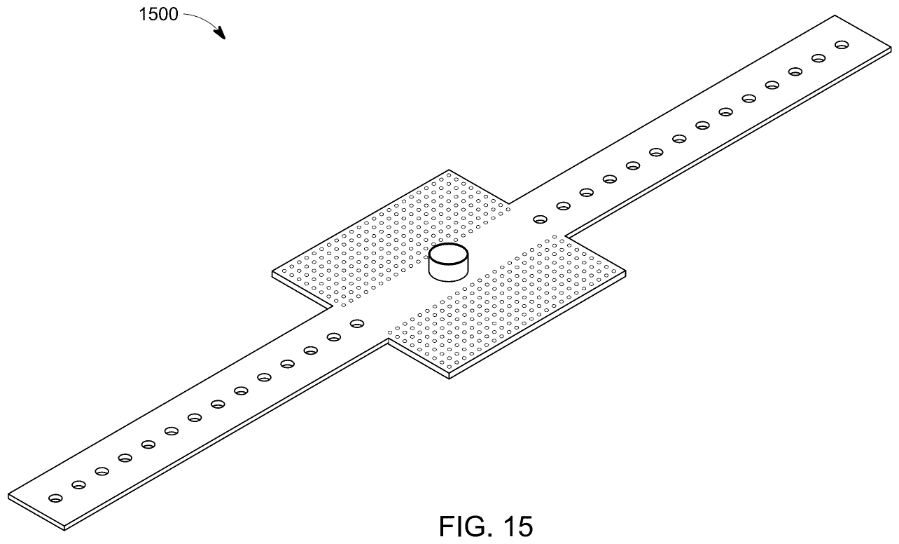

FIG. 15 illustrates a top view of the alternative embodiment of the low voltage wire holder 1200. This view may show the layout of multiple circular openings 1202, 1204 and any additional features incorporated into the top surface, such as cable management channels 1502 or equipment mounting points 1504.

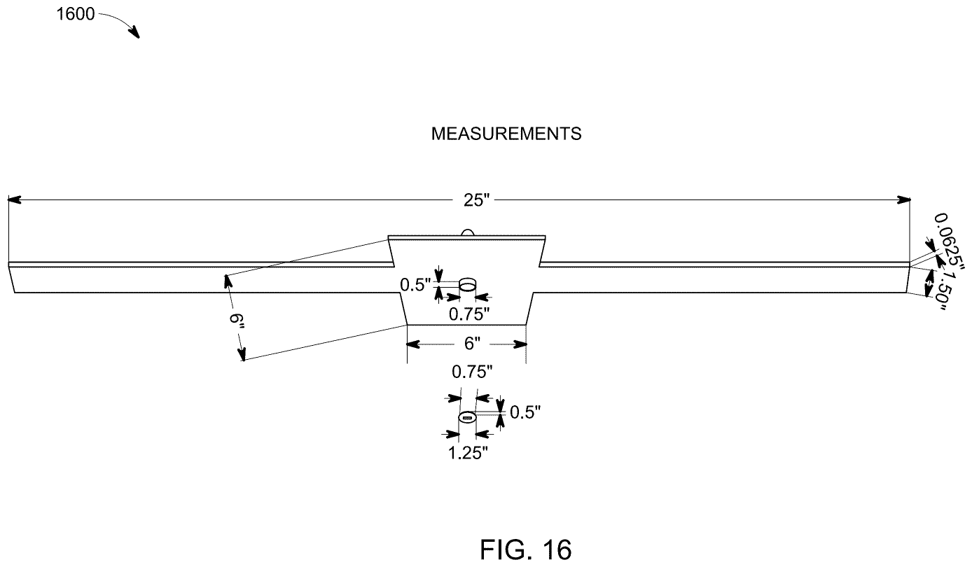

Turning to FIG. 16, a cross-sectional view of the alternative embodiment of the low voltage wire holder 1200 is depicted. This view may reveal internal structures or reinforcements 1602 that may be incorporated to enhance the strength and durability of the holder. It may also show how different sizes of circular openings 1202, 1204 may be accommodated within the same holder design.

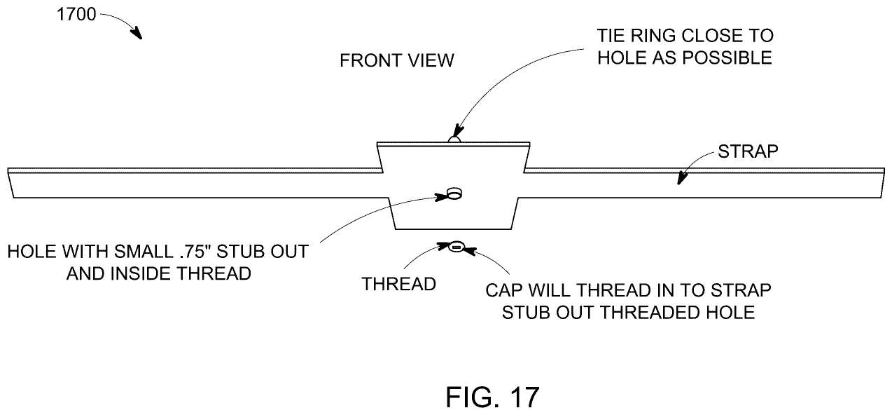

FIG. 17 presents a detailed view of a modified drywall guide 1700 that may be incorporated into either the original or alternative embodiment of the low voltage wire holder. The modified drywall guide 1700 may feature enhanced wire protection elements 1702 or adjustable components 1704 to accommodate different thicknesses of drywall.

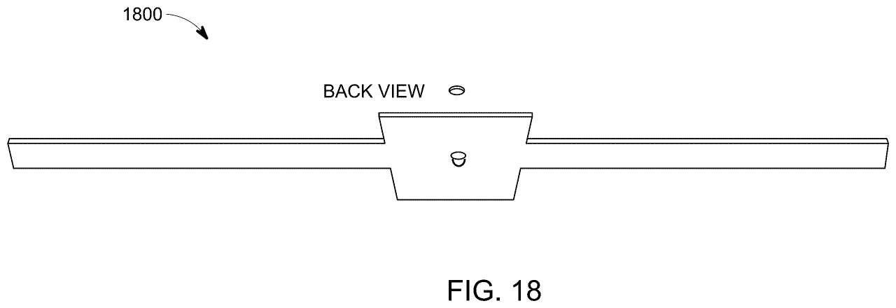

Finally, FIG. 18 illustrates a perspective view of a modular version of the low voltage wire holder 1800. This version may allow for multiple holders to be connected together to create larger wire management systems. The modular design may include interlocking features 1802 on the sides of the holders and standardized connection points 1804 for easy expansion and customization of the wire management system.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A low voltage wire holder apparatus, comprising:
a square surface having a circular opening;
two elongated boards extending from the square surface for attachment to at least one of: a wall, ceiling studs, and other part of framing;
a drywall guide on the square surface; and
an end cap configured to cover the circular opening.

2. The apparatus of claim 1, wherein the square surface is configured to provide a mounting point for equipment.

3. The apparatus of claim 1, wherein the circular opening is configured to provide access to pre-run wires behind drywall.

4. The apparatus of claim 1, wherein the drywall guide is configured to protect wires during drywall installation.

5. The apparatus of claim 1, further comprising a wire strap on a back side of the square surface.

6. The apparatus of claim 1, further comprising a wire hole on the square surface.

7. The apparatus of claim 1, wherein the apparatus is constructed of PVC.

8. A method of using a low voltage wire holder, comprising:
installing the low voltage wire holder between wall studs before drywall installation;
running low voltage wires through the holder;
accessing pre-run wires through a circular opening in the holder after drywall installation; and
installing equipment by screwing directly into a square surface of the holder.

9. The method of claim 8, further comprising covering the circular opening with an end cap when access to the wires is not needed.

10. The method of claim 8, wherein the low voltage wire holder comprises a drywall guide configured to protect the wires during drywall installation.

11. The method of claim 8, further comprising securing the wires using a wire strap on a back side of the holder.

12. The method of claim 8, wherein the low voltage wire holder is constructed of PVC.

13. A system for managing low voltage wires in building construction, comprising:
a low voltage wire holder apparatus including:
a square surface having a circular opening;
two elongated boards extending from the square surface for attachment to at least one of: a wall, ceiling studs, and other part of framing;
a drywall guide on the square surface;
an end cap configured to cover the circular opening; and
low voltage wires configured to be run through the apparatus.

14. The system of claim 13, wherein the square surface is configured to provide a mounting point for equipment.

15. The system of claim 13, wherein the circular opening is configured to provide access to the low voltage wires behind drywall.

16. The system of claim 13, wherein the drywall guide is configured to protect the low voltage wires during drywall installation.

17. The system of claim 13, further comprising a wire strap on a back side of the square surface.

18. The system of claim 13, further comprising a wire hole on the square surface.

19. The system of claim 13, wherein the apparatus is constructed of PVC.

20. The system of claim 13, further comprising equipment configured to be mounted directly to the square surface of the apparatus.
